(19) United States
(12) Patent Application Publication
(10) Pub. No.: US 2010/0270822 A1
(43) Pub. Date: Oct. 28, 2010

(54) MOUNTING STRUCTURE OF VEHICLE SEAT AND VEHICLE THAT INCLUDES MOUNTING STRUCTURE OF VEHICLE SEAT

(75) Inventor: Yuji Fujitsuka, Toyota-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/754,808

(22) Filed: Apr. 6, 2010

(30) Foreign Application Priority Data
Apr. 23, 2009 (JP) JP2009-105261

(51) Int. Cl. B60N 2/015; B60N 2/06; B60N 2/005

(52) U.S. Cl. 296/65.13; 296/63

(57) ABSTRACT

In a mounting structure of a vehicle seat, a side member and a bracket that support a vehicle seat form an enclosed section. Because the rigidity of the side member and the bracket may be secured, the mounting rigidity of the vehicle seat may be secured and the weight of the side member and the bracket thereby reduced. A pair of sidewalls formed in the side member face each other in the vehicle lateral direction, and a pair of connecting walls formed in the bracket are connected to the pair of sidewalls while facing the pair of sidewalls. If a forward and upward load is applied to the vehicle seat due to a sudden reduction in vehicle speed, a shearing force acts on the sidewall and the connection wall in relation to each other. Thus, sufficient durability of the connecting part may be ensured.

### INCORPORATION BY REFERENCE

The disclosure of Japanese Patent Application No. 2009-105261 filed on Apr. 23, 2009 including the specification, drawings and abstract is incorporated herein by reference in its entirety.

### BACKGROUND OF THE INVENTION

1. Field of the Invention

The present invention relates to mounting structures of a vehicle seat and vehicles that includes the vehicle seat mounting structures.

2. Description of the Related Art

Japanese Patent Application Publication No. 2008-68736 (JP-A-2008-68736) describes a conventional mounting structure of a vehicle seat. In an example of JP-A-2008-68736, sliding seat-rails are arranged on an upper surface of a rear floor, and the sliding seat-rails are fixed to the rear floor. The sliding seat-rails are connected, through a pair of connecting members, with a rear side frame (vehicle body frame) that is joined to a lower surface of the rear floor.

In the example of JP-A-2008-68736, the rear side frame and the pair of connection members form an open cross-section. Because of this, in order to secure mounting rigidity of the seat slide rail, the rear side frame and the pair of connecting members need to be made thicker, for example. However, doing so increases the weight of the vehicle.

A connecting part between the rear floor and the sliding seat-rail and the connecting part between the rear side frame and the connecting member are positioned in the vertical direction in the vehicle side view. When the vehicle reduces speed abruptly and the load acts on the vehicle front side and the vehicle upside to the vehicle seat (to the inclined direction in relation to the vertical direction of the vehicle), torsional force is applied to the connecting part between the rear side frame and the connecting member around the connecting part between the rear floor and the seat slide rail. To ensure sufficient durability of the connecting part between the rear side frame and the connecting member, the strength of the connecting part needs to be increased, for example.

When a bottom wall of the rear side frame has a datum hole that is formed for positioning purposes in welding, water may enter from the datum hole and then enter to a gap between a flange of the rear side frame and a lower surface of the rear floor, and as a result the flange can get rusted.

### SUMMARY OF THE INVENTION

The present invention provides a mounting structure of a vehicle seat and a vehicle including the mounting structure of a vehicle seat, in which mounting rigidity is secured, weight of the vehicle member and connection member is reduced, and weather resistance is improved.

A mounting structure of a vehicle seat according to a first aspect of the present invention includes: a floor panel; a vehicle body member that includes, a pair of sidewalls facing each other in a vehicle lateral direction, and a bottom wall that is connected to the lower ends of the sidewalls, wherein the vehicle body member is positioned below the floor panel and is connected to the floor panel; a connecting member that includes, a pair of connecting walls that are connected to the pair of sidewalls respectively while facing each other, and an upper wall that is positioned above the bottom wall and that is connected to the pair of connecting walls, the connecting member being positioned below the floor panel and forming an enclosed section with the vehicle body member; and a vehicle seat that is positioned above the floor panel and that is connected to the floor panel and the upper wall.

In the above vehicle seat mounting structure, the vehicle body member and the connection member that support the vehicle seat form an enclosed section. Because sufficient rigidity of the vehicle body member and the connection member may be secured by having a closed cross section, the mounting rigidity of the vehicle seat can be secured, and the weight of the vehicle body member and the connection member can be reduced (for example the connection member can be made thinner).

Also, the connection member is provided with a pair of connection walls that continuously extend from the upper wall, and thereby the rigidity of the whole connection member is secured. Therefore, the weight of the vehicle member and the connection member can further be reduced.

The pair of sidewalls formed in the vehicle member face each other in the vehicle lateral direction, and the pair of connecting walls formed in the connecting member are connected to the pair of sidewalls while facing the pair of sidewalls. If a forward and upward load is applied to the vehicle seat due to a sudden reduction in vehicle speed, the shearing force acts on the sidewall and the connection wall in relation to each other. Thus, durability of the connection part between the sidewall and the connection wall can be secured.

The mounting structure of a vehicle seat may be built such that the connecting wall includes at least a first connecting portion that is connected to the sidewall on a vehicle rear side and vehicle downside relative to a second connecting portion of the floor panel and the upper wall and the vehicle seat.

In the mounting structure of a vehicle seat, the first connecting portion between the connecting wall and the sidewall is positioned on the vehicle rear side and vehicle downside relative to the second connecting portion of the floor panel and the upper wall and the vehicle seat. If a forward and upward load is applied to the vehicle seat due to a sudden reduction in vehicle speed, the first connecting portion between the sidewall and the connecting wall can be prevented from receiving the torsional force produced around the second connecting portion of the floor panel and the upper wall and the vehicle sheet. Thereby, durability of the first connecting portion may be secured without taking a preventive action to strengthen the first connecting portion between the sidewall and the connection wall.

The mounting structure of a vehicle seat may be configured such that, the vehicle body member includes a pair of flanges that extend in opposite lateral directions from the upper ends of the pair of sidewalls. The flanges are connected to the floor panel, and the pair of connecting walls are positioned between the pair of sidewalls.

In the mounting structure of a vehicle seat, the pair of connecting walls are positioned between the pair of sidewalls. For example, when the bottom wall of the vehicle body member has a datum hole that is formed for positioning purposes in welding, the connecting wall prevents water from entering through the datum hole and entering the gap between the flange and the floor panel. Thereby, corrosion of the flange may be prevented.

The mounting structure of a vehicle seat may be configured such that the connecting member includes a load-carrying part that links the second connecting part of the upper wall and the floor panel and the vehicle seat to the first connecting part between the sidewall and the connecting wall in the vehicle side view.

In this mounting structure of a vehicle seat, if a forward and upward load is applied to the vehicle seat due to a sudden reduction in vehicle speed, the load, which is applied to the second connecting portion of the upper wall and the floor panel and the vehicle seat, is efficiently delivered to the first connecting portion between the sidewall and the connecting wall by the load-carrying part. Therefore, the vehicle seat can be prevented from being displaced when the vehicle reduces the speed suddenly, for example.

A minivan according to a second aspect of the present invention includes the mounting structure of the vehicle seat according to the first aspect of the present invention.

According to the present invention, the mounting rigidity of the vehicle seat can be secured, the weight of the vehicle body member and the connection member can be reduced (for example, the vehicle body member and the connection member can be made thinner), and the durability of the connection part between the sidewall and the connection wall can be secured.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a plan view of an interior of a vehicle that includes a mounting structure of a vehicle seat according to an embodiment of the present invention;

FIG. 2 is a perspective view that shows a portion of the mounting structure of a vehicle seat according to an embodiment of the present invention;

FIG. 3 is a front cross sectional view of the part shown in FIG. 2;

FIG. 4 is a side view of a portion shown in FIG. 2;

FIG. 5 is a front cross sectional view that shows another portion of the mounting structure of a vehicle seat according to an embodiment of the present invention;

FIG. 6 is a side view of a portion shown in FIG. 5;

FIG. 7 shows a modified embodiment of the mounting structure of a vehicle seat according to the present invention;

FIG. 8 is a perspective view of a bracket shown in FIG. 7;

FIG. 9 shows another modified embodiment of the mounting structure of a vehicle seat according to the present invention;

FIG. 10 is a perspective view of a bracket shown in FIG. 9;

FIG. 11 is a front cross sectional view of the mounting structure of a vehicle seat according to a first comparative example;

FIG. 12 is a front cross sectional view of the mounting structure of a vehicle seat according to a second comparative example; and

FIG. 13 is a side view of the mounting structure of a vehicle seat according to a third comparative example.

### DETAILED DESCRIPTION OF EMBODIMENTS

Hereinafter, an embodiment of the present invention will be described with reference to the drawings.

The arrows UP, FR, and OUT that are shown in the drawings indicate an upside in the vehicle vertical direction, a front side in the vehicle longitudinal direction, and an outside in the vehicle lateral direction, respectively.

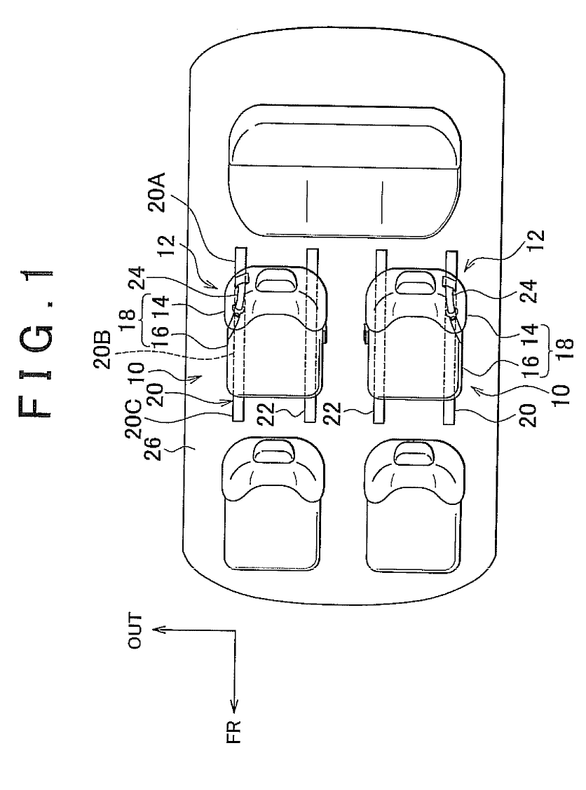

A vehicle seat 12 shown in FIG. 1 is for example a seat in a second row in the vehicle such as minivan. The vehicle seat 12 includes: a seat body 18 that has a seat back 14 and a seat cushion 16; and a pair of slide rails 20 and 22 that support the seat body 18 movably in the vehicle longitudinal direction. The seat body 18 integrally includes a seat belt device 24.

The vehicle seat 12 is provided on the right side of the vehicle and the vehicle seat 12 arranged on the left side of the vehicle are symmetrically structured. Therefore, the description will focus on the vehicle seat 12 arranged on the right side of the vehicle.

The slide rails 20 and 22 are arranged above the floor panel 26 and may be attached to the vehicle body at three places for example in the vehicle longitudinal direction by a mounting structure 10 of the vehicle seat according to an embodiment of the present invention.

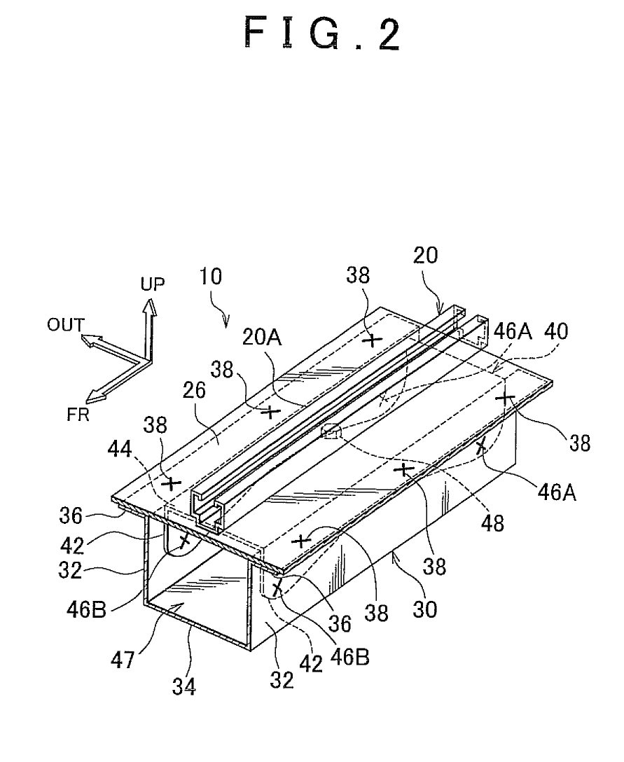

That is, the rear portion 20A of the slide rails 20 is mounted on the vehicle body by the structure shown in FIG. 2 to FIG. 4. As shown in these drawings, a side member 30 as a vehicle body member and a bracket 40 as a connection member are disposed below the floor panel 26.

The side member 30 is arranged on the outside in the vehicle lateral direction in the vehicle body, and extends in the vehicle longitudinal direction. The side member 30 includes: a pair of sidewalls 32 that face each other in the lateral direction of the vehicle; a bottom wall 34, provided below the sidewalls, that connects the side walls; and a pair of flanges 36 that separate from each other and extend in the vehicle lateral direction formed along the top portion of each sidewall 32 that extend in opposite directions along the lateral direction of the vehicle. The flanges 36 are connected to the floor panel 26 by a connection part 38 by welding, for example.

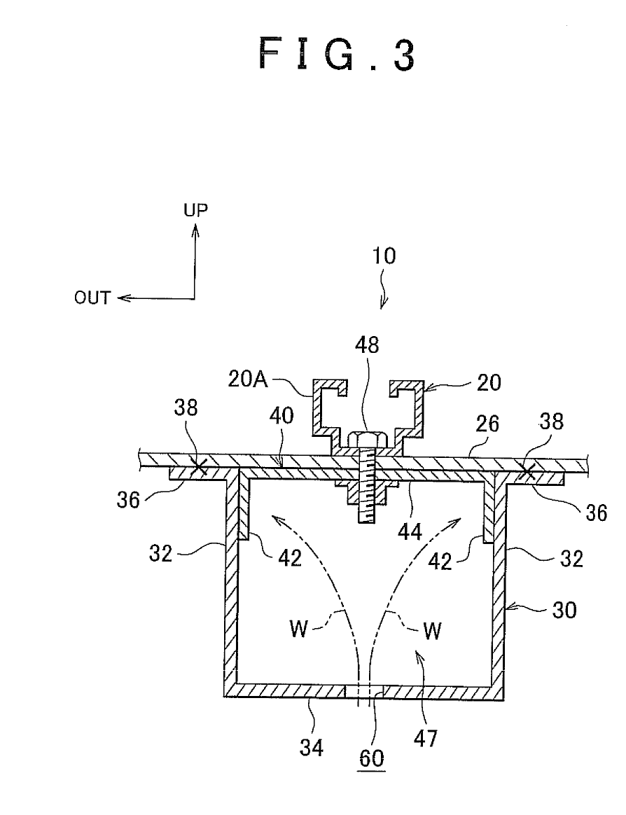

The bracket 40 includes: a pair of parallel connecting walls 42 that face each other in the vehicle lateral direction; and an upper wall 44 that is positioned on the vehicle upside of the bottom wall 34 and that connects the pair of connection walls 42. The pair of connecting walls 42 are positioned between and parallel to the pair of sidewalls 32. The pair of connecting walls 42 are connected to the pair of sidewalls 32 respectively by the connection parts 46A and 46B by welding, for example. Thereby, the bracket 40 together with the side member 30 forms a closed section 47, as shown in FIG. 3.

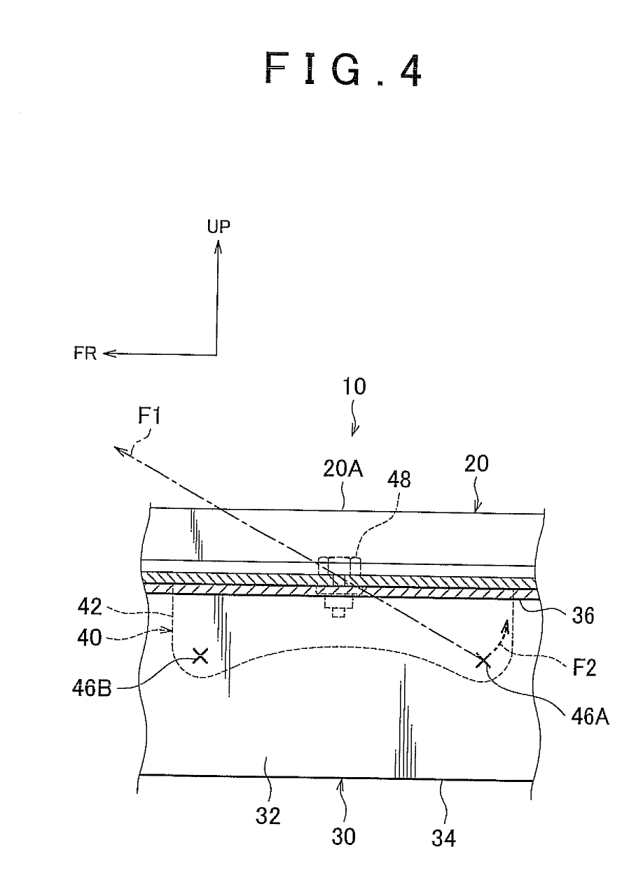

As shown in FIG. 4, the rear connecting part 46A among the above mentioned connection parts 46A and 46B is positioned on the vehicle rear side and vehicle downside relative to a fastening member 48 described later. If a forward and upward load is applied to the vehicle seat 12 due to a sudden reduction in vehicle speed, the fastening member 48 receives a load F1 that is directed forward and upward with respect to the vehicle. The connecting part 46A is positioned on the extended line of the load F1. The load F1 is, for example, defined by a seat belt anchorage test (such as Federal standard FMVSS 210).

The slide rail 20 overlaps with the side member 30 in the plan view of the vehicle. The rear portion 20A of the slide rail 20 is connected to the floor panel 26 and the upper wall 44 by the fastening member 48. The fastening member 48 may be any suitable fastening means, such as, for example, a bolt and a weld nut.

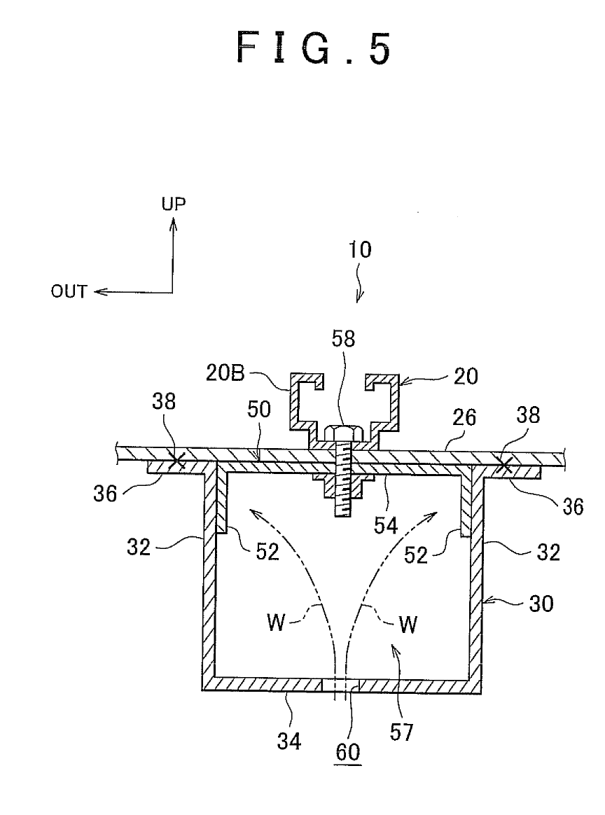

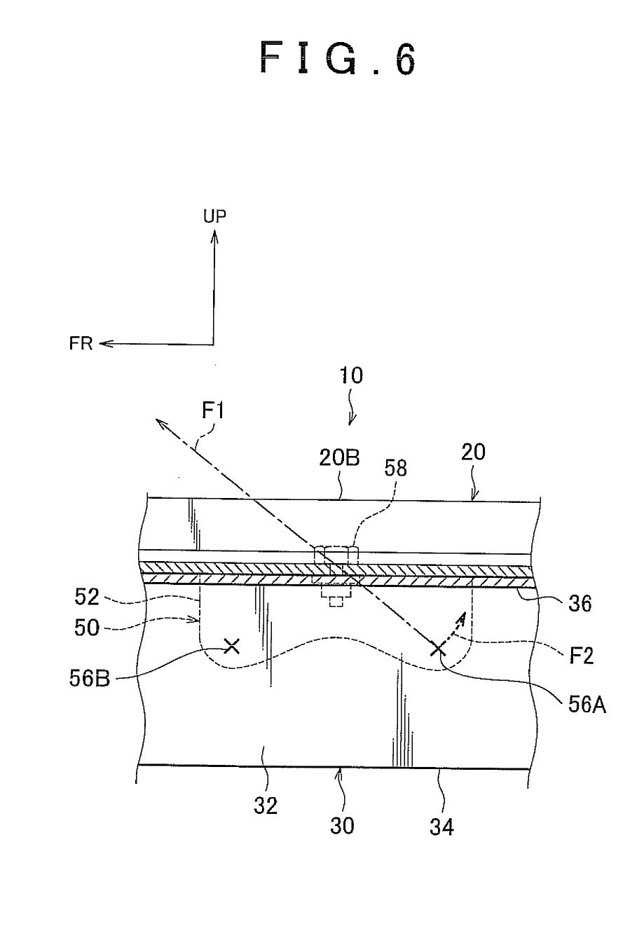

A longitudinal central portion 20B of the slide rail 20 (see FIG. 1) is attached to the vehicle body by the same structure as described above. That is, as shown in FIG. 5 and FIG. 6, the bracket 50 as a fastening member is disposed below the floor panel 26.

The structure of the bracket 50 is identical to that of the bracket 40. As shown in FIG. 5, the bracket 50 includes: a pair of connecting walls 52 that face each other in the vehicle lateral direction; and an upper wall 54 that is positioned above the bottom wall 34 and that connects the pair of connecting walls 52. The pair of connecting walls 52 are positioned between the pair of sidewalls 32 and face the pair of sidewalls 32 respectively. The pair of connecting walls 52 are connected to the pair of sidewalls 32 respectively by the connection parts 56A and 56B by welding, for example. Thereby, the bracket 50 forms a closed section 57 with the side member 30.

As shown in FIG. 6, in the same way as the connecting part 46A, the connecting part 56A, which is the rear side portion among the above mentioned connecting parts 56A and 56B, is positioned to the rear of and below a fastening member 58, described below, and at the same time positioned on the extended line of the load F1.

Because the bracket 50 is provided further towards the front of the vehicle relative to the bracket 40, the inclination angle of the load F1 that is applied to the fastening member 58 to the horizontal direction is larger than an inclination angle of the F1 applied on the fastening member 48 to the horizontal direction.

The longitudinal center portion 20B of the slide rail 20 may be connected to the floor panel 26 and the upper wall 54 using the fastening member 58 as a connection part such as a bolt and a weld nut.

Although not shown, a front portion 20C (refer to FIG. 1) of the slide rail 20 is fixed to the vehicle body using the same structure as that described above. However, the front portion 20C of the slide rail 20 may be fixed to the vehicle body using any suitable mounting structure.

Likewise, the slide rail 22 is fixed to the vehicle body using the same structure as the slide rail 20. However, the vehicle body is provided with a pair of floor cross members that extend in the vehicle lateral direction and with a linking member that links the floor cross members. The slide rail 22 is connected to the linking member instead of the side member 30.

Next, the function and effect of an embodiment according to the present invention will be described.

First, a comparative example is described in order to clarify the function and effect of the embodiment of the present invention. Here, only the structure of the rear part 20A in the slide rail 20 is compared and described. In the comparative example, the members that have the same names as an embodiment of the present invention described above are denoted by the same reference numerals and symbols.

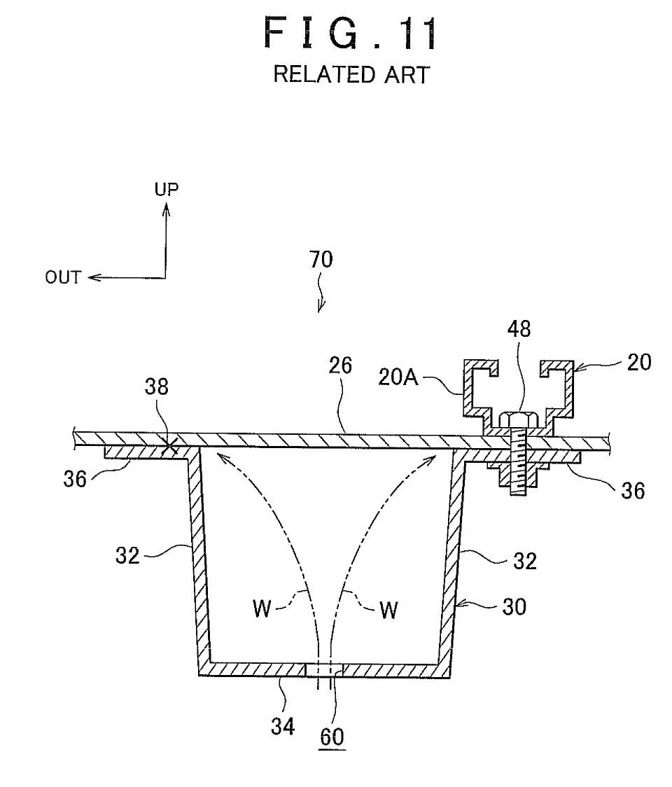

In a mounting structure 70 of a vehicle seat according to a first comparative example, shown in FIG. 11, the bracket 40 (refer to FIG. 2 to FIG. 4) of the mounting structure 10 is omitted. In addition, the slide rail 20 is connected to the flange 36 of the side member 30 and the floor panel 26 by the fastening member 48.

In the mounting structure 70 of a vehicle seat according to the first comparative example, the weight may be reduced because the bracket 40 is omitted. However, the side member 30 forms an open section, which reduces the mounting rigidity of the slide rail 20.

If the bottom wall 34 of the side member 30 has a datum hole 60 that is formed for positioning purposes in welding, water can enter through the datum hole 60 into a gap between the flange 36 and the floor panel 26, and thereby lead to corrosion of the flange 36.

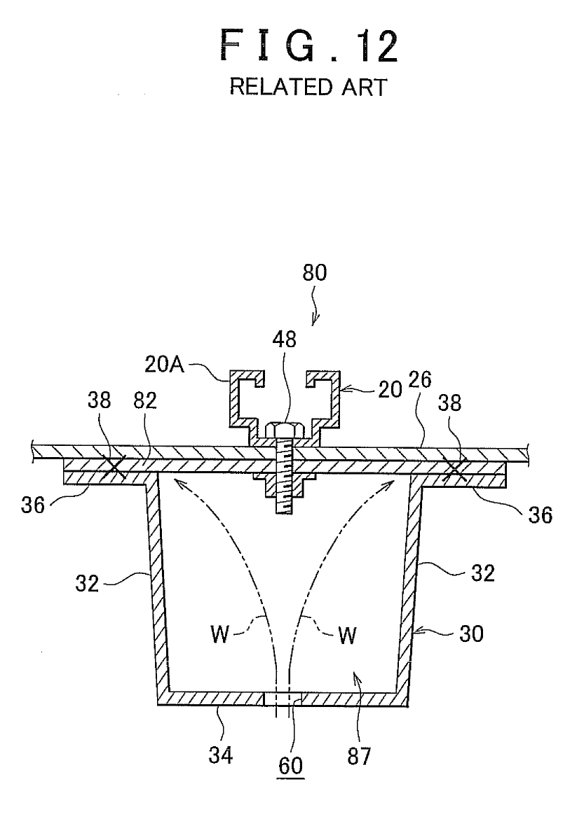

In the mounting structure 80 of a vehicle seat according to a second comparative example shown in FIG. 12, a reinforcing plate 82 is provided instead of the bracket 40 (refer to FIG. 2 to FIG. 4) as compared to the mounting structure 10 of a vehicle seat according to an embodiment of the present invention. The flange 36 is connected to the reinforcing plate 82 and the floor panel 26 by welding three layers. In addition, the slide rail 20 is connected to the reinforcing plate 82 and the floor panel 26 through the fastening member 48.

In the mounting structure 80 of a vehicle seat according to the second comparative example, the reinforcing plate 82 and the side member 30 form a closed section 87. Accordingly, the mounting rigidity of the slide rail 20 can be secured. However, in order to weld the flange 36, the reinforcing plate 82, and the floor panel 26 in three layers, the thickness of each plate is limited, so that the degree of freedom in plate thickness decreases.

If a forward and upward load is applied to the vehicle seat 12 (refer to FIG. 1) due to a sudden reduction in vehicle speed, the load is imposed in the direction that separates the flange 36, the reinforcing plate 82, and the floor panel 26 in relation to each other. Accordingly, the flange 36, the reinforcing plate 82, and the floor panel 26 may actually become separated. Accordingly, in order to ensure adequate durability of the connecting part 38 to connect those members, the strength of the connection part 38 needs to be increased, for example.

If the bottom wall 34 of the side member 30 has a datum hole 60 that is formed for positioning purposes in welding, water may enter through the datum hole 60 into a gap between the flange 36 and the reinforcing plate 82, and thereby lead to corrosion of the flange 36.

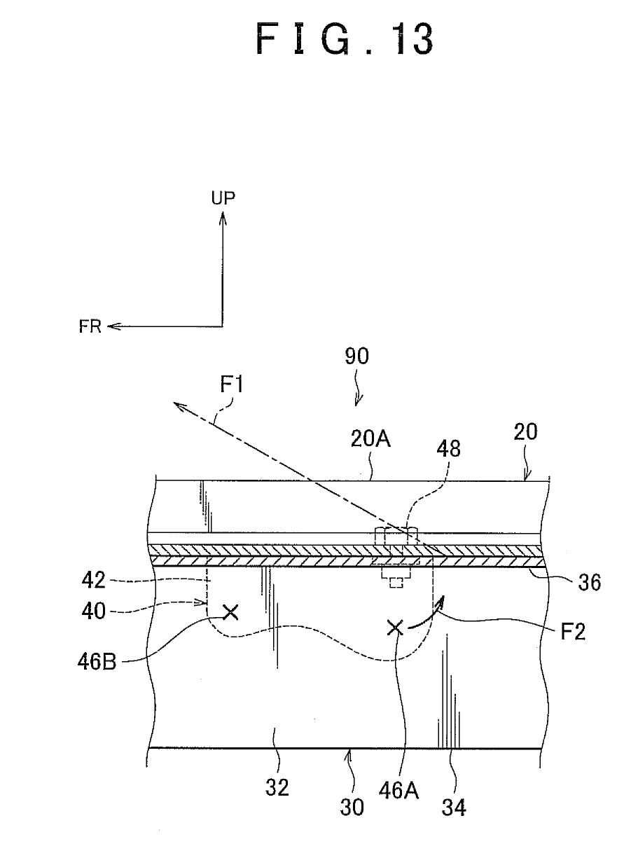

In a mounting structure 90 of a vehicle seat according to a third comparative example, shown in FIG. 13, the connecting part 46A is provided over the fastening member 48 in the vehicle side view, unlike the mounting structure 10 of a vehicle seat according to an embodiment of the present invention.

Because of this structure, if a forward and upward load is applied to the vehicle seat 12 shown in FIG. 1 (or, when the load is applied in the inclined direction in relation to the vehicle vertical direction) due to a sudden reduction in vehicle speed, torsional force F2 is exerted around the fastening member 48 and applied on the connection part 46A. Accordingly, in order to ensure sufficient durability of the connection part 46A, the strength of the connection part 46 needs to be increased, for example.

In contrast, in the mounting structure 10 of a vehicle seat according to an embodiment of the present invention, as shown in FIG. 3, the side member 30 and the bracket 40, which both support the slide rail 20, form the closed section 47. Because the sufficient rigidity of the side member 30 and the bracket 40 may be ensured, the mounting rigidity of the slide rail 20 may be secured and at the same time the weight of the side member 30 and the bracket 40 may be reduced (for example the side member 30 and the bracket 40 can be made thinner).

Furthermore, the bracket 40 is provided with a pair of connecting walls 42 that extend continuously from the upper wall 44, and thereby ensuring sufficient rigidity of the whole bracket 40. Therefore, the weight of the side member 30 and the bracket 40 may be further reduced.

As shown in FIG. 2 and FIG. 3, the pair of sidewalls 32, which are formed in the side member 30, face each other in the vehicle lateral direction. The pair of connection walls 42, which are formed in the bracket 40, are connected to the pair of sidewalls 32 while facing each other. Accordingly, if a forward and upward load is applied to the vehicle seat 12 (refer to FIG. 1) due to a sudden reduction in vehicle speed, the shearing force acts on the sidewall 32 and the connection wall 42 in relation to each other. Thus, sufficient durability of the connection parts 46A and 46B may be ensured.

As shown in FIG. 4, the connecting part 46A on the vehicle rear side is positioned behind and below the fastening member 48. If a forward and upward load is applied to the vehicle seat 12 (refer to FIG. 1) due to a sudden reduction in vehicle speed, the connecting part 46A mostly receives the pull force and is prevented from receiving the torsional force F2 that is produced around the fastening member 48. Thereby, sufficient durability of the connecting part 46A may be ensured without taking a preventive action to strengthen the connection part 46A.

As shown in FIG. 3, the pair of connecting walls 42 are positioned between the pair of sidewalls 32. For example, if the bottom wall 34 of the side member 30 has a datum hole that is formed for positioning purposes in welding, the connection wall 42 prevents the water, from entering through the datum hole 60 into the gap between the flange 36 and the floor panel 26. Thereby, corrosion of the flange 36 may be avoided.

If a small gap is formed between the sidewall 32 and the connection wall 42, the connecting wall 42 still prevents the water from entering through the datum hole 60 into the gap between the flange 36 and the floor panel 26. In addition, if electropaint is to be applied, the sidewall 32 and the connection wall 42 may be electropainted because the paint enters to the gap between the sidewall 32 and the connection wall 42.

A modified embodiment of the present invention is described below.

In the above embodiment, the side member 30 serves as an example of the vehicle member. However, a bracket that is connected to the side member 30 or a reinforcing member that is connected to the floor panel 26 may be used instead of the side member 30.

In the above embodiment, the vehicle seat 12 is provided with the slide rails 20 and 22. However, the vehicle seat 12 may be mounted to the vehicle body by the above structure in which the slide rails 20 and 22 are omitted.

In the above embodiment, the vehicle seat 12 is a second row seat in the vehicle such as minivan. However, the vehicle seat 12 may be located somewhere other than the second row. Also, the vehicle seat 12 may also be provided in vehicles other than minivan.

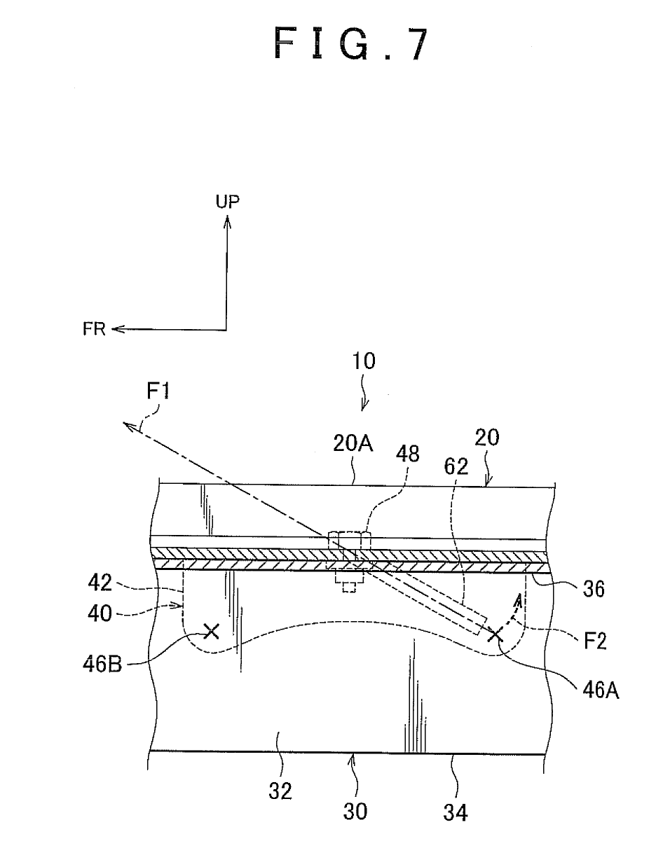

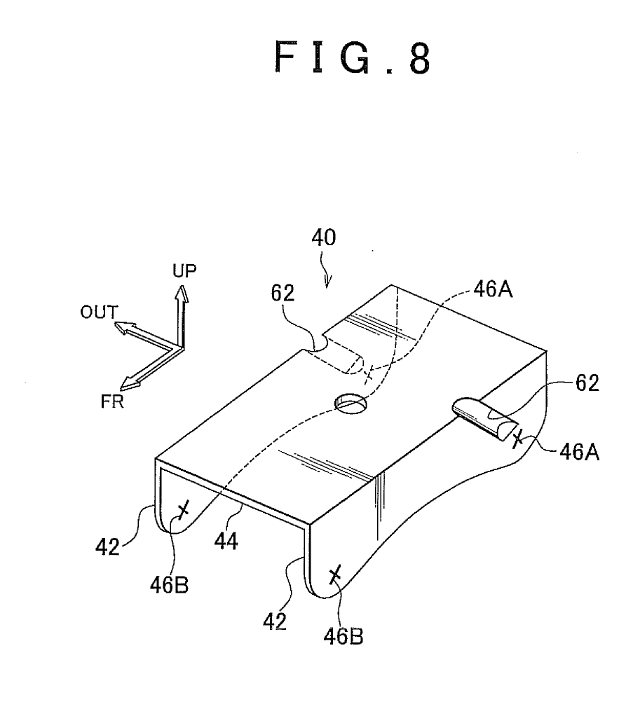

In the above embodiment, the bracket 40 may be configured in the following ways. In the modified embodiment shown in FIG. 7 and FIG. 8, the pair of connection walls 42 are provided with a bead 62 that serves as the load-carrying portion that links the fastening member 48 to the connecting portion 46A in the vehicle side view.

In the above configuration, if a forward and upward load is applied to the vehicle seat 12 (refer to FIG. 1) due to, for example, a sudden reduction in vehicle speed, the load that is applied to the fastening member 48 is efficiently transferred to the connecting portion 46A by the bead 62. Therefore, the vehicle seat 12 can be prevented from being displaced when the vehicle suddenly reduces speed.

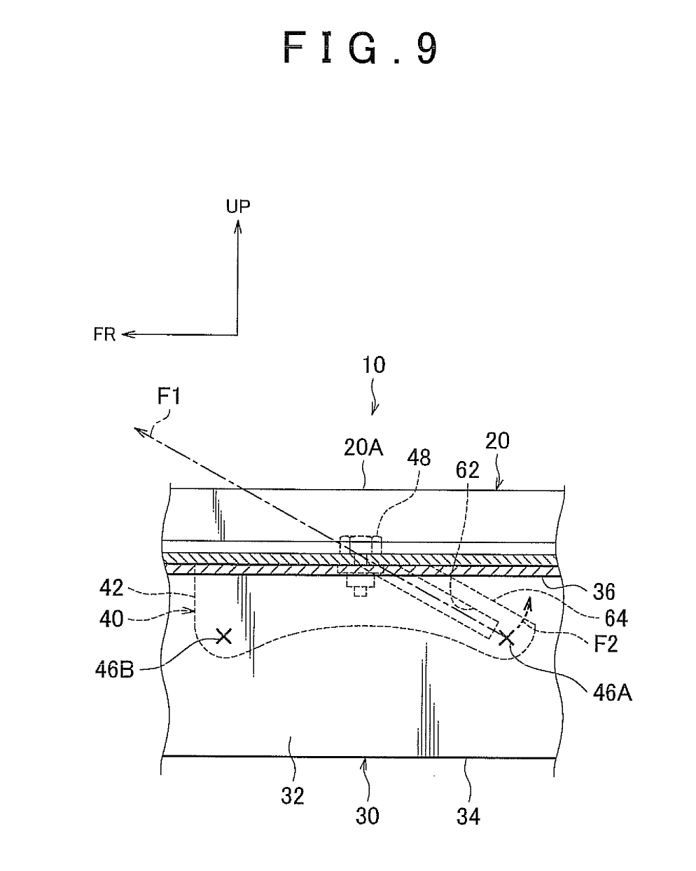

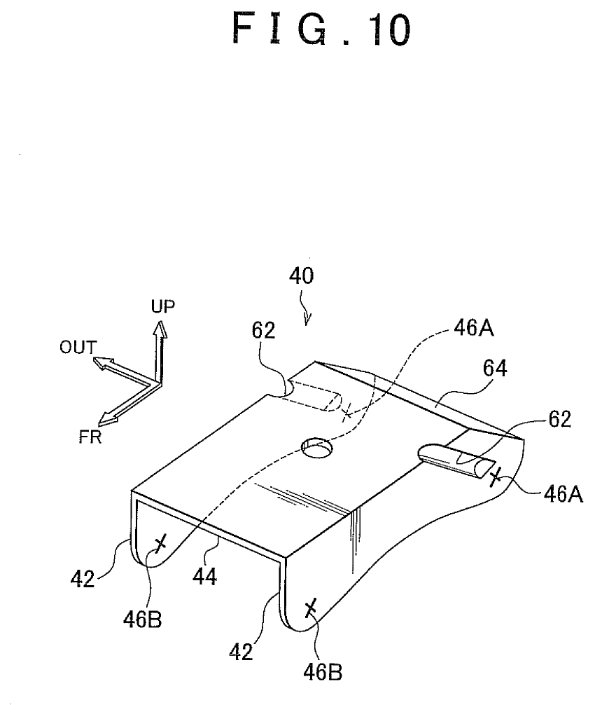

In the modified embodiment shown in FIG. 9 and FIG. 10, in addition to the bead 62 that is formed in the pair of connecting walls 42, the upper wall 44 is provided with an inclined portion 64 that serves as the load-carrying part that links the fastening member 48 to the connecting portion 46A in the vehicle side view.

With such a structure, the load applied to the fastening member 48 is more efficiently transferred to the connecting portion 46A by the bead 62 and the inclined portion 64. Therefore, displacement of the vehicle seat 12 when the vehicle suddenly reduces speed is further reduced.

The bracket 50 may also be provided with at least one of the bead 62 and the inclined portion 64 in the same way as the bracket 40.

The embodiment of the present invention and its modifications are described above. The present invention is not limited to the above description but may be modified in various ways as appropriate to carry out its intended purpose.

What is claimed is:

1. A mounting structure of a vehicle seat, comprising:
a floor panel;
a vehicle body member that includes, a pair of sidewalls facing each other in a vehicle lateral direction, and a bottom wall that is connected to lower ends of sidewalls, wherein the vehicle body member is positioned below the floor panel and is connected to the floor panel;
a connecting member that includes, a pair of connecting walls that are connected to the pair of sidewalls respectively while facing each other, and an upper wall that is positioned above the bottom wall and that is connected to the pair of connecting walls, the connecting member being positioned below the floor panel and forming an enclosed section with the vehicle body member; and
a vehicle seat that is positioned above the floor panel and that is connected to the floor panel and the upper wall.

2. The mounting structure of a vehicle seat according to claim 1, wherein the connecting wall includes at least a first connecting portion that is connected to the sidewall on a vehicle rear side and vehicle downside relative to a second connecting portion of the floor panel and the upper wall and the vehicle seat.

3. The mounting structure of a vehicle seat according to claim 1, wherein
the vehicle body member includes a pair of flanges that extend in opposite lateral directions with respect to the vehicle from upper ends of the sidewalls and that are connected to the floor panel, and
the pair of connecting walls are positioned between the pair of sidewalls.

4. The mounting structure of a vehicle seat according to claim 2, wherein the connecting member includes a load-carrying portion that links the second connecting portion of the upper wall and the floor panel, and the vehicle seat to the first connecting portion between the sidewall and the connection wall in the vehicle side view.

5. The mounting structure of a vehicle seat according to claim 4, wherein the load-carrying portion is a bead.

6. The mounting structure of a vehicle seat according to claim 1, wherein the vehicle seat is fixed to the floor panel and the upper wall.

7. The mounting structure of a vehicle seat according to claim 1, wherein the vehicle seat is fixed to the floor panel and the upper wall through a slide rail on which the vehicle seat is slidably mounted.

8. A minivan comprising the mounting structure of a vehicle seat according to claim 1.
